(19) United States
(12) Patent Application Publication
(10) Pub. No.: US 2009/0120901 A1
(43) Pub. Date: May 14, 2009

(54) PATTERNED ELECTRODES WITH REDUCED RESIDUE

(75) Inventors: Lawrence Keith White, Princeton Junction, NJ (US); Joseph Thomas McGinn, Flemington, NJ (US)

Correspondence Address: PEARL, COHEN, ZEDEK & LATZER, LLP, 1500 BROADWAY, 12TH FLOOR, NEW YORK, NY, 10036, US

(73) Assignee: PixelOptics Inc.

(21) Appl. No.: 12/246,643

(22) Filed: Oct. 7, 2008

Related U.S. Application Data
(60) Provisional application No. 60/986,612, filed on Nov. 9, 2007.

(51) Int. Cl. B44C 1/22

(52) U.S. Cl. 216/13

(57) ABSTRACT

Aspects of the present invention provide patterned electrodes with substantially reduced or removed residue. Aspects of the present invention for removing residue are applicable to any fabricated structure including transparent electrodes. By substantially reducing or removing residue typically associated with methods used to form patterned electrodes, an improvement in performance can be realized by ensuring that the deposition of subsequent materials onto a substrate is not adversely affected by any such residue. In turn, better interconnects can be formed and better coverage of subsequent layers can be achieved. The method for producing patterned electrodes with substantially reduced or removed residue in accordance with the present invention can be used in conjunction with any known method for patterning conductors or electrodes.

### CROSS-REFERENCE TO RELATED APPLICATIONS

This application claims priority from and incorporates by reference in their entirety the following provisional applications:

U.S. Appl. No. 60/986,612, filed on Nov. 9, 2007.

### BACKGROUND OF THE INVENTION

1. Field of the Invention

The present invention generally relates to the formation of patterned electrodes. More specifically, the present invention provides patterned electrodes having reduced associated residue.

2. Background Art

Electrodes may be patterned or shaped for a variety of applications. For example, transparent conductors may be patterned for use as electrodes in many electrical devices including liquid crystal displays (LCDs) and electro-active (EA) lenses. The conductors often comprise indium tin oxide (ITO) and can be used to form a diffractive phase profile in a layer of EA material.

FIGS. 1A-1F illustrate a first process for patterning an electrode. More specifically, FIGS. 1A-1F illustrate an exemplary etching process. Generally, with an etching process, a resist image is patterned on a substrate after depositing a conductor onto the substrate.

As shown in FIG. 1A, the etching process can begin with a substrate 102. The substrate 102 can be any substrate suitable for a desired application. For example, the substrate 102 can comprise a substantially transparent substrate such as, but not limited to, glass, plastic, ceramic or any combination thereof.

FIG. 1B illustrates a conductor 104 deposited on the substrate 102. The conductor 104 can be a transparent conductor such as, but not limited to, ITO. In many applications, it may desirable to coat or cover the entirety of the substrate 102 with the conductor 104. Further, the conductor 104 may be of uniform thickness. FIG. 1C illustrates an etch resist 106 deposited on the covered substrate 102. In particular, the etch resist 106 can coat or cover the conductor layer 104 that is deposited on the substrate 102. The etch resist 106 can be any etch resist. As an example, the etch resist 106 can be a light sensitive resist such as, but not limited to, a photo-resist.

FIG. 1D illustrates a patterned etch resist 106. The etch resist 106 can be patterned using a variety of know techniques such as, but not limited to, using a mask or projecting a pattern onto the etch resist 106 optically. For example, a mask can be placed over the etch resist 106 depicted in FIG. 1C. The mask can expose certain portions of the etch resist 106 to a light source. Alternatively, a desired pattern for the etch resist 106 can be projected onto the etch resist 106 optically from a light source. Under either method, after exposure to a light source, the etch resist 106 can be exposed to a solution that dissolves or removes exposed or developed portions of the etch resist 106. As a result, a desired patterned etch resist 106 is left or remains on the substrate 102.

FIG. 1E illustrates an etched conductor 104. To form the etched conductor 104, the conductor 104 and patterned etch resist 106 depicted in FIG. 1D can be placed into a suitable etching medium. The etching medium can be gaseous or can be a liquid. When placed in the etching medium, the portion of the conductor 104 that is not covered by the etch resist 106 can be removed. The remaining conductor 104 can form a desired pattern or shape.

FIG. 1F illustrates the removal of the remaining etch resist 106. To remove the etch resist 106, organic solvents or oxygen plasma, or a combination thereof, can be used. Once the etch resist 106 is removed, the desired patterned conductor 104 remains on the substrate 102. The patterned conductor 104 can be an ITO film.

FIGS. 2A-2E illustrate a second process for patterning an electrode. More specifically, FIGS. 2A-2E illustrate an exemplary lift-off process. Generally, with a lift-off process, a resist image is patterned on a substrate prior to applying a conductor onto the substrate. Further, for a desired patterned conductor structure, the resist image will be of the opposite tone as the resist image used in an etching process (e.g., the exemplary etching process depicted in FIGS. 1A-1F).

As shown in FIG. 2A, the lift-off process can begin with the substrate 102. FIG. 2B illustrates the etch resist 106 deposited on the substrate 102. The etch resist 106 need not be an etch resist per se but can be a light sensitive resist such as, but not limited to, a photo-resist.

FIG. 2C illustrates a patterned etch resist 106. The etch resist 106 can be patterned using a variety of know techniques such as, but not limited to, using a mask or projecting a pattern onto the etch resist 106 optically. For example, a mask can be placed over the etch resist 106 depicted in FIG. 1C. The mask can expose certain portions of the etch resist 106 to a light source. Alternatively, a desired pattern for the etch resist 106 can be projected onto the etch resist 106 optically from a light source. Under either method, after exposure to a light source, the etch resist 106 can be exposed to a solution that dissolves or removes exposed or developed portions of the etch resist 106. As a result, a desired patterned etch resist 106 is left or remains on the substrate 102.

FIG. 2D illustrates the conductor 104 deposited on the patterned etch resist 106 and the exposed substrate 102. FIG. 2E illustrates a patterned conductor 104 after removal of the patterned etch resist 106. The patterned etch resist 106 can be removed, for example, by using organic solvents or oxygen plasma, or a combination thereof. During this process, the conductor 104 deposited on top of the patterned etch resist 106 can also be removed, thereby leaving the desired patterned conductor 104. The patterned conductor 104 can be an ITO film.

The etching process depicted in FIGS. 1A-1F and the lift-off process depicted in FIGS. 2A-2E can both cause residues to be left on a substrate. Specifically, both processes can leave behind unwanted portions of conductor film on or around desired patterned conductor structures. Such residue or remnants are undesirable as they can lead to a large variety of problems in subsequent processing steps including, but not limited to, poor step coverage of dielectric films and subsequent conductive layers, dielectric pinholes, contaminated dielectrics and conductor/interconnect films, poorly defined interconnects, and open or shorted interconnects.

As a particular example of residues forming or being left behind during a lift-off process, conductor material can be deposited on a sidewall of a resist image. FIGS. 3A-3B illustrates the formation of residue during fabrication of a patterned electrode. FIG. 3A illustrates conductor material 104 deposited on the sidewalls of the etch resist 106 that forms a desired resist image. As shown in FIG. 3B, when the etch resist 106 is removed, residue material 302 can be formed. The residue material 302 can be conductor material 104 that remains on the edge of a desired patterned electrode structure 104. This residue material 302 should be removed prior to the deposition of additional material (e.g., dielectric, conductive or resistive layers) onto the substrate 102. Additionally, during a lift-off process, residue material 302 can be formed or left behind on other portions of the patterned conductor 104 or between patterned conductor structures 104.

Similar to deficiencies in traditional lift-off processes, traditional etching processes (e.g., reactive-ion etching (RIE)) can leave residues at the edge of patterned conductor features. Further, dry etching procedures that produce volatile organo-metallics for etching a conductor can also leave sputtered and condensed conductor material on the sidewalls of a resist. When the resist is stripped, these residues can be left behind at the edge and on the top of the patterned conductor features. Again, these residues should be removed prior to the deposition of other material on top of the patterned conductor.

No matter the method of patterning conductor electrodes, the removal of any residues remains costly, time-consuming and difficult under current methods. Therefore, what is needed is a method for producing patterned conductor electrodes with reduced residue. Such a method should be applicable to any method for patterning electrodes and should not introduce costly or overly disruptive additional manufacturing steps.

### BRIEF DESCRIPTION OF THE DRAWINGS/FIGURES

FIGS. 1A-1F illustrate a first process for patterning an electrode.

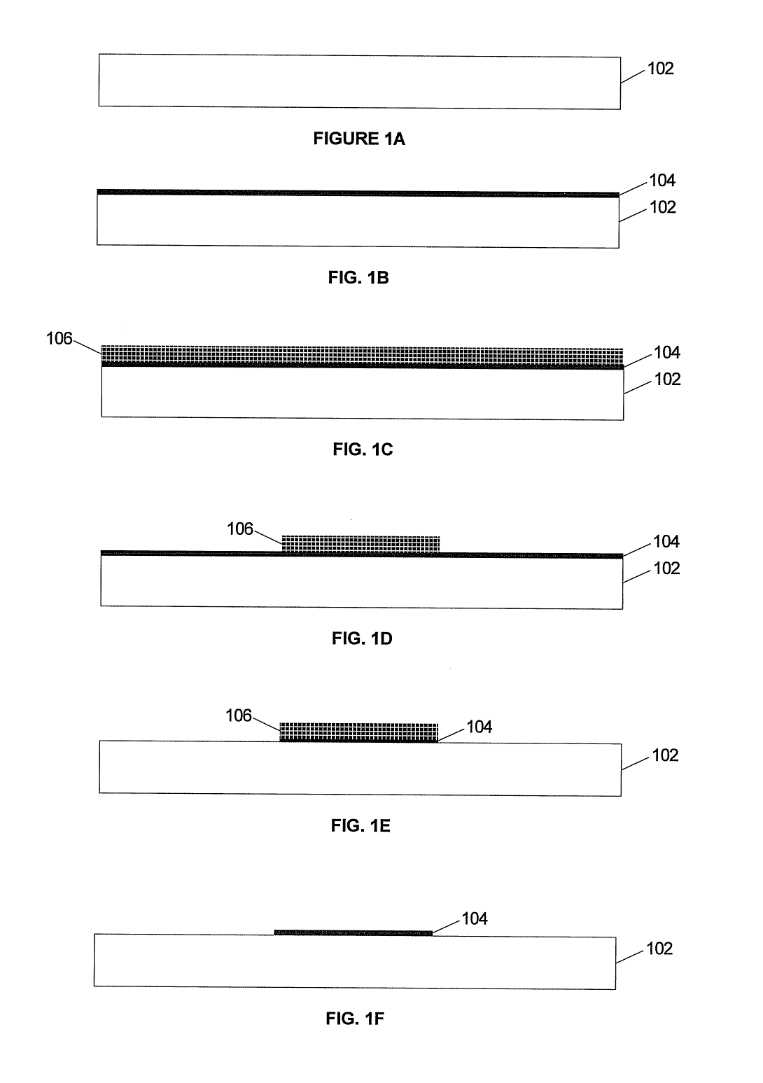

FIGS. 2A-2E illustrate a second process for patterning an electrode.

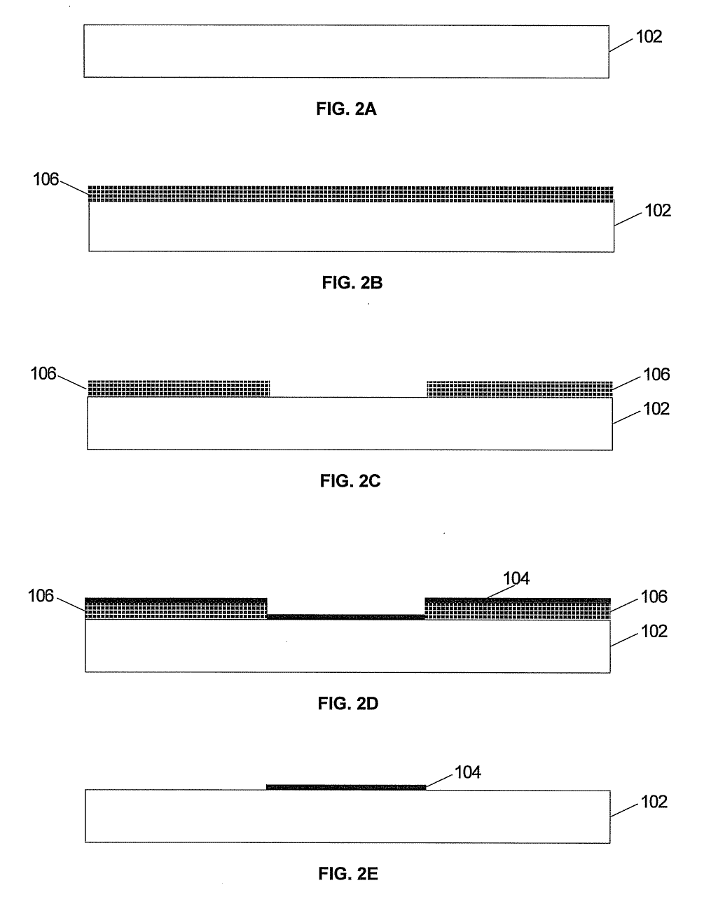

FIGS. 3A-3B illustrates the formation of residue during fabrication of a patterned electrode.

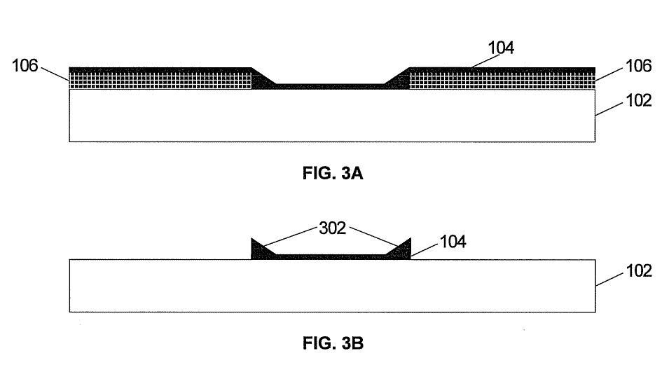

FIG. 4 provides a flowchart that illustrates operational steps for forming patterned electrodes with reduced residue in accordance with an aspect of the present invention.

### DETAILED DESCRIPTION OF THE INVENTION

Aspects of the present invention provide patterned electrodes with substantially reduced or removed residue. Aspects of the present invention for removing residue are applicable to any fabricated structure including transparent electrodes. By substantially reducing or removing residue typically associated with methods used to form patterned electrodes, an improvement in performance can be realized by ensuring that the deposition of subsequent materials onto a substrate is not adversely affected by any such residue. In turn, better interconnects can be formed and better coverage of subsequent layers can be achieved.

The method for producing patterned electrodes with substantially reduced or removed residue in accordance with the present invention can be used in conjunction with any known method for patterning conductors or electrodes. In particular, aspects of the present invention can be used to reduce residues associated with patterned electrodes fabricated as disclosed in U.S. patent application Ser. No. 12/018,048, filed on Jan. 22, 2008, in U.S. patent application Ser. No. 12/166,526, filed on Jul. 2, 2008, and U.S. patent application Ser. No. 12/042,643, filed on Mar. 5, 2008, which are all hereby incorporated by reference in their entirety.

After a conductor film has been patterned (e.g., an ITO film) and a resist initially removed according to traditional methods that may leave behind residue, an aspect of the present invention provides for the patterned film to be further treated with a diluted or weak etchant. The etchant can remove the unwanted residues while limiting the reduction of the size or dimensions of the formed patterned structures. According to an aspect of the present invention, an amount of size reduction of the patterned structures due to the weak etchant can be determined such that larger structures can be initially formed to account for any subsequent reduction in size.

A first weak etchant of the present invention can be a solution comprising hydrochloric acid (HCl), nitric acid (HNO₃) and water (H₂0)—that is, HCl—HNO₃—H₂0. As an example, the mixture can comprise 10 parts (by volume; e.g., 10 mL) of HCl, 1 part (by volume; e.g., 1 mL) of HNO₃ and 500 to 2000 parts (by volume; e.g., 500 mL to 2000 mL) of H₂0. A second weak etchant of the present invention can be a solution comprising ferric chloride (FeCl₃), HCl and H₂0—that is, FeCl₃—HCl—H₂0. A third weak etchant of the present invention can be a solution comprising cupric chloride (CuCl₂), HCl and H₂0—that is, CuCl₂—HCl—H₂0.

Any of the etchants of the present invention can be applied to any patterned structure including, but not limited to, an ITO film. The etchants of the present invention can be applied at room temperature or can be heated prior to application to a patterned structure. Additionally, the etchants of the present invention can be applied for various amounts of time to a patterned structure. For example, etch times can vary from 10 seconds to over 1 minute. A reduction in size of a patterned structure can increase a sheet resistance of the patterned structure. Therefore, in general, application of an etchant of the present invention may be designed to minimize or limit the reduction in a size of the patterned structure to a tolerable amount.

In accordance with an aspect of the present invention, the solution used to remove residue can be varied, the proportions of the chemicals in the selected solution can be varied, the temperature of the solution can be varied and the application time of the solution can be varied. One or more of these variations can be used to determine an expected size reduction of the treated structure. For example, by accounting for the composition and size of the structure to be treated and the variations in application of a selected residue removing solution, an expected reduction in size of the treated structure can be determined or estimated. This expected or estimated size reduction can be taken into account during initial formation of the structure (pre-residue removal) such that the structure can be made larger than a final desired size. A final desired size of the structure can be achieved after application of the residue removing solution of the present invention.

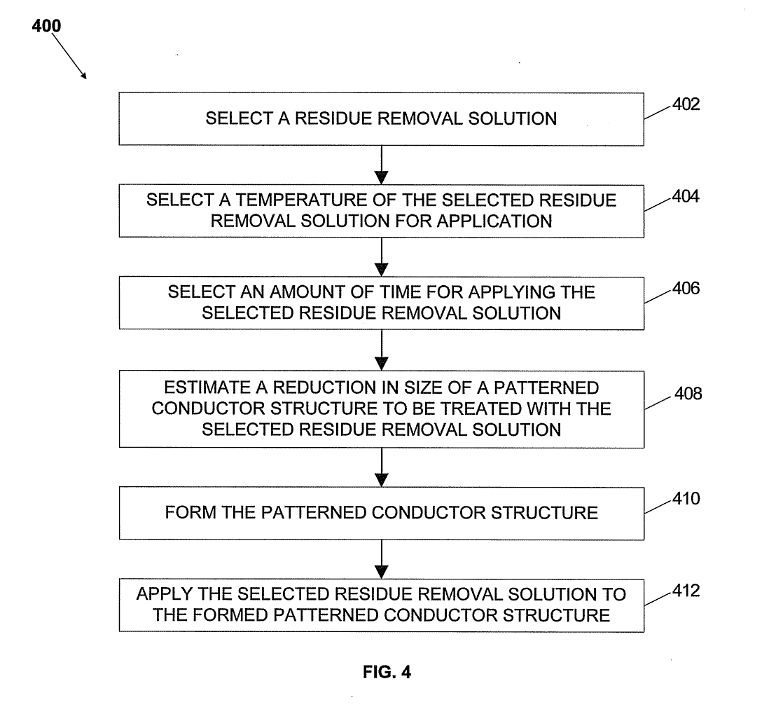

FIG. 4 provides a flowchart 400 that illustrates operational steps for forming patterned electrodes with reduced residue in accordance with an aspect of the present invention. The operation steps can be used to form patterned electrodes of a desired size while accounting for any reduction in size that may occur due to application of a residue removal solution of the present invention. In this way, patterned electrodes having a desired size, shape and sheet resistance can be formed with significantly reduced residue or absent residue altogether.

The invention is not limited to this operational description. Rather, it will be apparent to persons skilled in the relevant art(s) from the teachings herein that other operational control flows are within the scope and spirit of the present invention. In the following discussion, the steps in FIG. 400 are described.

At step 402, a residue removal solution is selected. The residue removal solution can be any of the above mentioned solutions including HCl—HNO₃—H₂0, FeCl₃—HCl—H₂0 and CuCl₂—HCl—H₂0.

At step 404, a temperature for application of the selected residue removal solution can be selected. The temperature of the selected residue removal solution during application can be room temperature or can vary from room temperature.

At step 406, an amount of time for applying the selected residue removal solution is selected. The application time can be any time including, but not limited to, a time ranging from 10 seconds to 1 minute.

At step 408, a reduction in a size of a patterned conductor structure to be treated with the selected reside removal solution can be estimated. The amount of size reduction—across any dimension—can be estimated based on a variety of factors including: composition of the patterned conductor structure; composition of the selected residue removal solution; the determined application temperature of the selected residue removal solution; and the determined application time of the selected residue removal solution. Based on an estimate on the reduction in size of a patterned structure, a corresponding increase in sheet resistance can be determined. One skilled in the pertinent art(s) will understood that estimations of the decrease in size and increase in sheet resistance of a patterned conductor structures can be based on empirical results from applying etch mixtures of various concentrations and temperatures to conductor structures of known dimensions and sheet resistance and measuring changes due to the application of said etch mixtures.

At step 410, a patterned structure can be formed. The patterned structure can be a patterned electrode. The patterned electrode can comprise ITO. The patterned electrode can be formed by an etching process or by a lift-off process. Further, the patterned electrode can be formed to compensate for the estimated reduction in size expected to occur due to subsequent application of the selected residue removal solution. That is, the patterned electrode can be formed to be large than desired such that, after treatment with the residue removal solution, the initially formed patterned electrode with be reduced to a final, desired size.

At step 412, the selected residue removal solution can be applied to the patterned structure formed in step 410. The residue removal solution can be applied in accordance with the determined application temperature and the determined application time.

After application of the residue removal solution, a patterned electrode can be provided with significantly reduced residue or with residue absent entirely. Further, the treated patterned electrode can be of a desired size and sheet resistance by accounting for an estimated reduction in size of the initially formed, pre-treated patterned electrode. As an example, application of the residue removal solution can be such that the sheet resistance of the initially formed patterned electrode can increase by no more than 10%.

As a variation of the operational steps depicted in the flowchart 400, as will be appreciated by one skilled in the pertinent art(s), a selected residue removal solution can be applied to a preformed patterned electrode structure without pre-estimating an expected reduction in size prior to forming the patterned electrode. Under such a scenario, a solution composition, exposure time and temperature can be selected to keep any reduction in size to within a tolerable level while still meeting sheet resistance and size requirements.

### CONCLUSION

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A method, comprising:
selecting a residue removal solution;
selecting an application temperature of the selected residue removal solution;
selecting an application time of the selected residue removal solution;
estimating a reduction in a size of a patterned conductor structure to be treated with the selected residue removal solution based on a composition of the patterned conductor structure, a composition of the selected residue removal solution, the selected application temperature of the selected residue removal solution and the selected application time of the selected residue removal solution;
forming the patterned conductor structure; and
applying the selected residue removal solution to the formed patterned conductor structure to remove residue associated with formation of the patterned conductor structure in accordance with the selected application temperature and the selected application time of the selected residue removal solution.

2. The method of claim 1, wherein selecting the residue removal solution further comprises selecting a residue removal solution comprising HCl—HNO₃—H₂0.

3. The method of claim 2, wherein selecting the residue removal solution further comprises selecting a residue removal solution comprising 10 ml of HCl.

4. The method of claim 2, wherein selecting the residue removal solution further comprises selecting a residue removal solution comprising 1 ml of HNO₃.

5. The method of claim 2, wherein selecting the residue removal solution further comprises selecting a residue removal solution comprising between 500 ml and 2000 ml of H₂0.

6. The method of claim 1, wherein selecting the residue removal solution further comprises selecting a residue removal solution comprising FeCl₃—HCl—H₂0.

7. The method of claim 1, wherein selecting the residue removal solution further comprises selecting a residue removal solution comprising CuCl₂—HCl—H₂0.

8. The method of claim 1, wherein selecting an application temperature further comprises selecting the application temperature to be room temperature.

9. The method of claim 1, wherein selecting an application time further comprises selecting the application time to be a time ranging from 10 seconds to 1 minute.

10. The method of claim 1, wherein estimating further comprises estimating the reduction in the size of the patterned conductor structure to be treated based on the composition of the pattern conductor structure comprising indium tin oxide (ITO).

11. The method of claim 1, wherein forming the patterned conductor structure further comprises forming the patterned conductor structure according to an etching process.

12. The method of claim 1, wherein forming the patterned conductor structure further comprises forming the patterned conductor structure according to a lift-off process.

13. The method of claim 1, wherein forming the patterned conductor structure further comprises forming the patterned conductor structure to comprise ITO.

14. The method of claim 1, wherein forming the patterned conductor structure further comprises forming the patterned conductor structure to compensate for the estimated reduction in size of the patterned conductor structure based on applying the selected residue removal solution.

15. The method of claim 1, wherein applying further comprises applying the residue removal solution such that a sheet-resistance of the patterned conductor structure is increased by less than 10%.

16. A method, comprising:
selecting a residue removal solution;
selecting an application temperature of the selected residue removal solution;
selecting an application time of the selected residue removal solution;
applying the selected residue removal solution to a patterned conductor structure to remove residue associated with formation of the patterned conductor structure in accordance with the selected application temperature and the selected application time.

17. The method of claim 14, wherein applying further comprises increasing a sheet resistance of the patterned conductor structure by less than 10%.
